(19) United States
(12) Patent Application Publication
(10) Pub. No.: US 2021/0272453 A1
(43) Pub. Date: Sep. 2, 2021

(54) TIME-SERIES LEARNING DEVICE, TIME-SERIES LEARNING METHOD, TIME-SERIES PREDICTION DEVICE, TIME-SERIES PREDICTION METHOD, AND PROGRAM

(71) Applicant: NIPPON TELEGRAPH AND TELEPHONE CORPORATION, Tokyo (JP)

(72) Inventors: Koshin TO, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/257,786

(22) PCT Filed: Jul. 8, 2019
(86) PCT No.: PCT/JP2019/027006

§ 371 Date: Jan. 4, 2021

(30) Foreign Application Priority Data
Jul. 6, 2018 (JP) 2018-129353

(51) Int. Cl. G08G 1/056; G06N 3/08; G06N 3/04

(52) U.S. Cl. CPC G08G 1/056; G06N 3/0445; G06N 3/08

(57) ABSTRACT

An object is to make it possible to learn a prediction model for precisely predicting the number of passersby at a prediction time point. A learning unit 300 learns parameters of the prediction model with respect to each of a plurality of observation points based on learning data such that the number of passersby at the observation point at a prediction time point predicted using the prediction model matches the number of passersby at a time point corresponding to the prediction time point included in the learning data. The learning data includes, with respect to each observation point, a past time point of the observation point and the number of passersby at the observation point at the past time point. The prediction model has parameters including a first weight indicating the influence of the numbers of passersby at other observation points based on distances to the other observation points, a second weight indicating the influence of the numbers of passersby at the other observation points based on a travel route, and a third weight differing from the first weight and the second weight and indicating the influence of the numbers of passersby at the other observation points.

### TECHNICAL FIELD

The present invention relates to a time series learning apparatus, a time series learning method, a time series prediction apparatus, a time series prediction method, and a program, and particularly to a time series learning apparatus, a time series learning method, a time series prediction apparatus, a time series prediction method, and a program for predicting a future flow of people.

### BACKGROUND ART

It is essential to analyze flows of people in a large-scale facility in which an event or the like is held and a traffic facility such as a station to consider congestion situations in advance, relieve the congestion, make plans for emergency evacuation guidance, and the like.

As a technology for analyzing such a flow of people, there is a time series prediction technology (for example, NPL 1) for predicting the degree of congestion in the future based on observation data in the past.

### CITATION LIST

### Non Patent Literature

[NPL 1] J. D. Hamilton, “Time Series Analysis”, Princeton Univ Press, 1994.

### SUMMARY OF THE INVENTION

### Technical Problem

Usually, there are various restrictions (places at which observation devices can be installed, time zones, and the like) when observation data is collected, and some observation data pieces have strong correlation but others do not.

For example, if there are data pieces regarding the number of passersby that are measured at two different observation sites, usually, the shorter a travel distance between the observation sites is and the closer time zones in which the data pieces were observed are, the stronger correlation between the data pieces regarding the latest number of passersby tends to be.

Also, a travel route that many people pass may appear in a specific time zone depending on the observation site. For example, a travel route that many people pass while leaving work and going to a station appears in a time zone from the evening to the night.

As described above, correlation between observation data pieces varies according to geographical and temporal factors and the like, and therefore, in time series prediction, it is necessary to make adjustment as to which data among already obtained past observation data is used, the influence of which data is increased, and the like according to an observation point and conditions such as the time zone, in view of the correlation.

However, conventional technologies cannot deal with these problems or only partially deal with these problems, and therefore, there is a problem in that when time series prediction of the future is performed, precision of the prediction is low.

The present invention was made in view of the foregoing, and it is an object of the present invention to provide a time series learning apparatus, a time series learning method, and a program with which a prediction model for precisely predicting the number of passersby at a prediction time point can be learned.

It is another object of the present invention to provide a time series prediction apparatus, a time series prediction method, and a program with which the number of passersby at a prediction time point can be precisely predicted.

### Means for Solving the Problem

A time series learning apparatus according to the present invention is a time series learning apparatus configured to learn, with respect to each of a plurality of observation points, parameters of a prediction model for predicting the numbers of passersby at the observation points at a prediction time point based on the numbers of passersby at the observation points at an observation time point that are input, and includes: an input unit configured to accept input of learning data, a first weight, and a second weight with respect to each of the plurality of observation points, the learning data including a past time point of the observation point and the number of passersby at the observation point at the past time point, the first weight indicating the influence of the numbers of passersby at other observation points based on distances to the other observation points, the second weight indicating the influence of the numbers of passersby at the other observation points based on a travel route; and a learning unit configured to learn parameters of the prediction model with respect to each of the plurality of observation points based on the learning data such that the number of passersby at the observation point at a prediction time point predicted using the prediction model matches the number of passersby at a time point corresponding to the prediction time point included in the learning data, the prediction model having parameters including the first weight, the second weight, and a third weight that differs from the first weight and the second weight and indicates the influence of the numbers of passersby at the other observation points.

A time series learning method according to the present invention is a time series learning method for learning, with respect to each of a plurality of observation points, parameters of a prediction model for predicting the numbers of passersby at the observation points at a prediction time point based on the numbers of passersby at the observation points at an observation time point that are input, and includes: accepting, by an input unit, input of learning data, a first weight, and a second weight with respect to each of the plurality of observation points, the learning data including a past time point of the observation point and the number of passersby at the observation point at the past time point, the first weight indicating the influence of the numbers of passersby at other observation points based on distances to the other observation points, the second weight indicating the influence of the numbers of passersby at the other observation points based on a travel route; and learning, by a learning unit, parameters of the prediction model with respect to each of the plurality of observation points based on the learning data such that the number of passersby at the observation point at a prediction time point predicted using the prediction model matches the number of passersby at a time point corresponding to the prediction time point included in the learning data, the prediction model having parameters including the first weight, the second weight, and a third weight that differs from the first weight and the second weight and indicates the influence of the numbers of passersby at the other observation points.

According to the time series learning apparatus and the time series learning method according to the present invention, the input unit accepts input of learning data, a first weight, and a second weight with respect to each of the plurality of observation points. The learning data includes a past time point of the observation point and the number of passersby at the observation point at the past time point. The first weight indicates the influence of the numbers of passersby at other observation points based on distances to the other observation points. The second weight indicates the influence of the numbers of passersby at the other observation points based on a travel route.

Then, the learning unit learns parameters of the prediction model with respect to each of the plurality of observation points based on the learning data such that the number of passersby at the observation point at a prediction time point predicted using the prediction model matches the number of passersby at a time point corresponding to the prediction time point included in the learning data. The prediction model has parameters including the first weight, the second weight, and a third weight that differs from the first weight and the second weight and indicates the influence of the numbers of passersby at the other observation points.

As described above, parameters of the prediction model are learned with respect to each of the plurality of observation points based on learning data that includes, with respect to each of the plurality of observation points, a past time point of the observation point and the number of passersby at the observation point at the past time point. The parameters of the prediction model include a first weight that indicates the influence of the numbers of passersby at other observation points based on distances to the other observation points, a second weight that indicates the influence of the numbers of passersby at the other observation points based on a travel route, and a third weight that differs from the first weight and the second weight and indicates the influence of the numbers of passersby at the other observation points. The parameters are learned with respect to each observation point such that the number of passersby at the observation point at a prediction time point predicted using the prediction model matches the number of passersby at a time point corresponding to the prediction time point included in the learning data. Thus, a prediction model for precisely predicting the number of passersby at a prediction time point can be learned.

The prediction model of the time series prediction apparatus according to the present invention may also be a recurrent neural network.

A time series prediction apparatus according to the present invention is a time series prediction apparatus configured to predict the number of passersby at each of a plurality of observation points at a prediction time point by using a prediction model for predicting the numbers of passersby at the observation points at a prediction time point based on the numbers of passersby at the observation points at an observation time point, and includes: an input unit configured to accept input of observation data with respect to each of the plurality of observation points, the observation data including an observation time point of the observation point and the number of passersby at the observation point at the observation time point; and a prediction unit configured to predict the number of passersby at the observation point at the prediction time point from the observation data by using the prediction model that is learned in advance and has parameters including a first weight, a second weight, and a third weight with respect to the observation point, the first weight indicating the influence of the numbers of passersby at other observation points based on distances to the other observation points, the second weight indicating the influence of the numbers of passersby at the other observation points based on a travel route, the third weight differing from the first weight and the second weight and indicating the influence of the numbers of passersby at the other observation points.

A time series prediction method according to the present invention is a time series prediction method for predicting the number of passersby at each of a plurality of observation points at a prediction time point by using a prediction model for predicting the numbers of passersby at the observation points at a prediction time point based on the numbers of passersby at the observation points at an observation time point, and includes; accepting, by an input unit, input of observation data with respect to each of the plurality of observation points, the observation data including an observation time point of the observation point and the number of passersby at the observation point at the observation time point; and predicting, by a prediction unit, the number of passersby at the observation point at the prediction time point from the observation data by using the prediction model that is learned in advance and has parameters including a first weight, a second weight, and a third weight with respect to the observation point, the first weight indicating the influence of the numbers of passersby at other observation points based on distances to the other observation points, the second weight indicating the influence of the numbers of passersby at the other observation points based on a travel route, the third weight differing from the first weight and the second weight and indicating the influence of the numbers of passersby at the other observation points.

According to the time series prediction apparatus and the time series prediction method according to the present invention, the input unit accepts input of observation data with respect to each of the plurality of observation points. The observation data includes an observation time point of the observation point and the number of passersby at the observation point at the observation time point.

The prediction unit predicts the number of passersby at the observation point at the prediction time point from the observation data by using a prediction model that is learned in advance and has parameters including a first weight, a second weight, and a third weight with respect to the observation point. The first weight indicates the influence of the numbers of passersby at other observation points based on distances to the other observation points. The second weight indicates the influence of the numbers of passersby at the other observation points based on a travel route. The third weight differs from the first weight and the second weight and indicates the influence of the numbers of passersby at the other observation points.

As described above, the number of passersby at each of a plurality of observation points at a prediction time point is predicted from observation data that includes, with respect to each observation point, an observation time point of the observation point and the number of passersby at the observation point at the observation time point, by using a prediction model that is learned in advance and has parameters including a first weight, a second weight, and a third weight with respect to the observation point. The first weight indicates the influence of the numbers of passersby at other observation points based on distances to the other observation points, the second weight indicates the influence of the numbers of passersby at the other observation points based on a travel route, and the third weight differs from the first weight and the second weight and indicates the influence of the numbers of passersby at the other observation points. Thus, the number of passersby at a prediction time point can be precisely predicted.

A configuration is also possible in which the input unit of the time series prediction apparatus according to the present invention further accepts input of a first weight and a second weight with respect to the observation point, the first weight indicating the influence of the numbers of passersby at other observation points based on distances to the other observation points, the second weight indicating the influence of the numbers of passersby at the other observation points based on a travel route, and the prediction unit predicts the number of passersby at the observation point at the prediction time point from the observation data by using the first weight and the second weight accepted by the input unit as the first weight and the second weight included in the parameters of the prediction model.

A program according to the present invention is a program for causing a computer to function as each unit of the above-described time series learning apparatus or the above-described time series prediction apparatus.

### Effects of the Invention

With the time series learning apparatus, the time series learning method, and the program according to the present invention, a prediction model for precisely predicting the number of passersby at a prediction time point can be learned.

Also, with the time series prediction apparatus, the time series prediction method, and the program according to the present invention, the number of passersby at a prediction time point can be precisely predicted.

### BRIEF DESCRIPTION OF DRAWINGS

FIG. 1 is a conceptual diagram schematically showing prediction of the number of passersby performed by a time series learning and prediction apparatus according to an embodiment of the present invention.

FIG. 2 is a conceptual diagram indicating that position information is considered in prediction of the number of passersby performed by the time series learning and prediction apparatus according to an embodiment of the present invention.

FIG. 3 is a conceptual diagram indicating that a travel route is considered in prediction of the number of passersby performed by the time series learning and prediction apparatus according to an embodiment of the present invention.

FIG. 4 is a block diagram showing one example of a configuration of a time series learning and prediction apparatus according to a first embodiment of the present invention.

FIG. 5 is a conceptual diagram showing input and output of the time series learning and prediction apparatus according to the first embodiment of the present invention.

FIG. 6 is a flow chart showing a learning processing routine performed by the time series learning and prediction apparatus according to the first embodiment of the present invention.

FIG. 7 is a flow chart showing a prediction processing routine performed by the time series learning and prediction apparatus according to the first embodiment of the present invention.

FIG. 8 is a diagram showing a result of an experiment performed using the time series learning and prediction apparatus according to the first embodiment of the present invention.

FIG. 9 is a diagram showing a result of an experiment performed using the time series learning and prediction apparatus according to the first embodiment of the present invention.

FIG. 10 is a diagram showing a result of an experiment performed using the time series learning and prediction apparatus according to the first embodiment of the present invention.

FIG. 11 is a diagram showing one example of a network configuration in the case of deep learning performed by a time series learning and prediction apparatus according to a second embodiment of the present invention.

FIG. 12 is a flow chart showing a learning processing routine performed by the time series learning and prediction apparatus according to the second embodiment of the present invention.

### DESCRIPTION OF EMBODIMENTS

The following describes embodiments of the present invention using the Figures.

<Summary of Time Series Learning and Prediction Apparatus according to Embodiment of the Invention>

First, a summary of an embodiment of the present invention will be described.

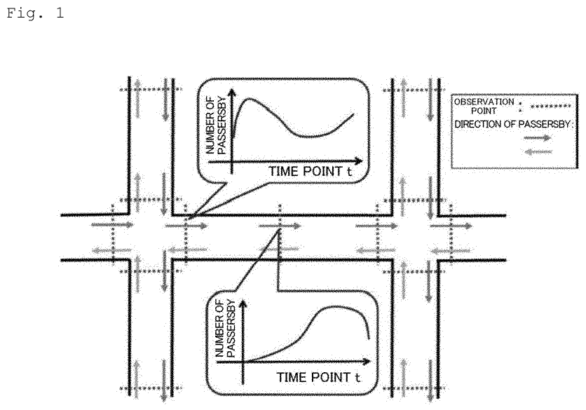

In the embodiment of the present invention, the number of passersby at each observation point in the future is predicted when there is observation data regarding the number of passersby observed in the past at the observation point (FIG. 1).

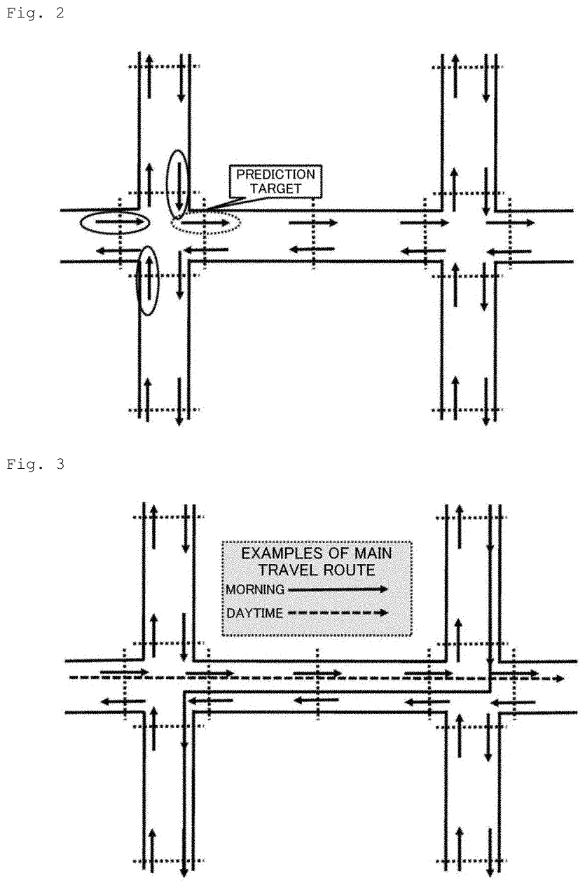

In the present embodiment, precision of time series prediction is improved by considering position information (FIG. 2), a travel route (FIG. 3), and the like between observation points.

In FIG. 2, if prediction is performed with respect to a time point that is close to an observation time point, the numbers of passersby at observation points (observation points surrounded by solid lines) that are close to a prediction target observation point (observation point surrounded by a dashed line) largely affect the prediction.

In this case, if only data regarding the close observation points is input, precision of the prediction is improved when compared to a case in which data regarding all observation points is input.

As described above, precision of prediction can be improved by weighting influence according to the prediction target observation point and the time point for which prediction is performed, while considering a distance to the prediction target observation point and the direction of travel.

Also, a main travel route of flows of people changes according to a time zone, a day of the week, the presence or absence of an event, and the like. For example, in FIG. 3, observation points through which a main travel route of people passes change between the morning and the daytime.

Precision of prediction can be improved by weighting influence while considering such a change of the travel route.

<Configuration of Time Series Learning and Prediction Apparatus according to First Embodiment of the Invention>

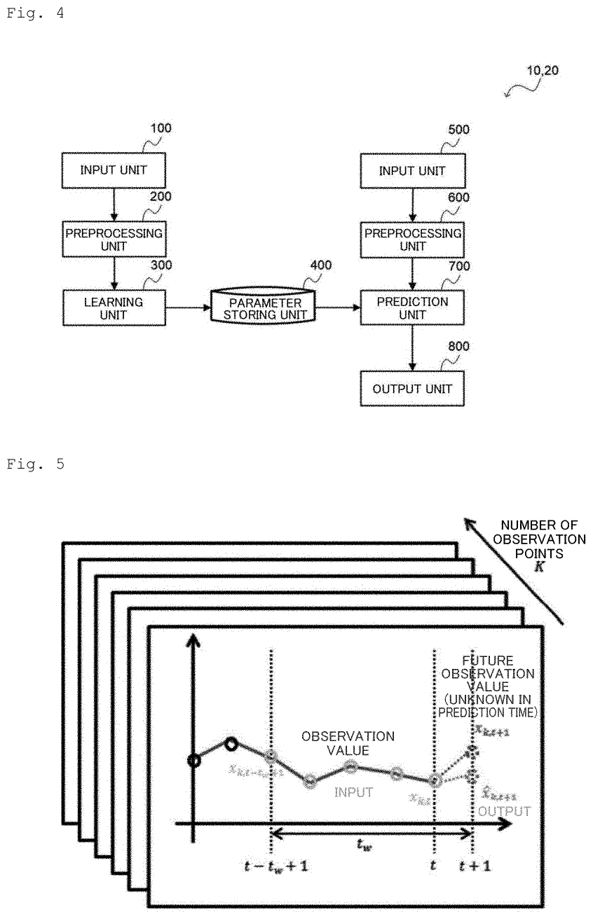

A configuration of a time series learning and prediction apparatus 10 according to an embodiment of the present invention will be described with reference to FIG. 4. FIG. 4 is a block diagram showing the configuration of the time series learning and prediction apparatus 10 according to an embodiment of the present invention.

The time series learning and prediction apparatus 10 is constituted by a computer that includes a CPU, a RAM, and a ROM in which a program for executing a learning processing routine and a prediction processing routine, which will be described later, is stored. The time series learning and prediction apparatus 10 has the following functional configuration.

As shown in FIG. 4, the time series learning and prediction apparatus 10 according to the present embodiment includes an input unit 100, a preprocessing unit 200, a learning unit 300, a parameter storing unit 400, an input unit 500, a preprocessing unit 600, a prediction unit 700, and an output unit 800.

The input unit 100, the preprocessing unit 200, and the learning unit 300 perform processing for learning a prediction model for predicting the number of passersby at an observation point at a prediction time point. The input unit 500, the preprocessing unit 600, the prediction unit 700, and the output unit 800 perform processing for predicting the number of passersby at the observation point at the prediction time point by using the learned prediction model.

The input unit 100 accepts the following three types of input with respect to each of a plurality of observation points. First input is learning data that includes a past time point of the observation point and the number of passersby at the observation point at the past time point. Second input is a first weight that indicates the influence of the numbers of passersby at other observation points based on distances to the other observation points. Third input is a second weight that indicates the influence of the numbers of passersby at the other observation points based on a travel route.

Specifically, the input unit 100 accepts input of X, [symbol] , [symbol] , K, T, t, t_{w}.

K is a constant that represents the number of observation points. If passersby travelling in different directions are observed at the same point, the point is taken to be different observation points. T is a constant that represents the length of an observation period, and T=[1,∞).

t_{w} is a constant that indicates a time width of the number of passersby in the past that is input to perform prediction. t_{w}=[1, ∞) and if t_{w}=1, for example, data regarding a just preceding time point is used as input in the prediction.

Also,

### X

represents the number of passersby (observation data) at each observation point. The number of passersby at an observation point k at a time point t is expressed as

X={x_{k,t}|k=[1,K],t=[1,T]}.

Xₜ is a K-dimensional vector expressed as

Xₜ=[x_{1,t},x_{2,t}, . . . ,x_{K,t}].

As described above, the time series learning and prediction apparatus 10 according to the present embodiment is aimed at predicting the numbers of passersby

Xₜ₊₁=[x_{1,t+1},x_{2,t+1}, . . . ,x_{K,t+1}]

at K observation points at a time point t+1, when the numbers of passersby

Xₜ₋ₜ_{_{w}}₊₁,Xₜ₋ₜ_{_{w}}₊₂, . . . ,Xₜ

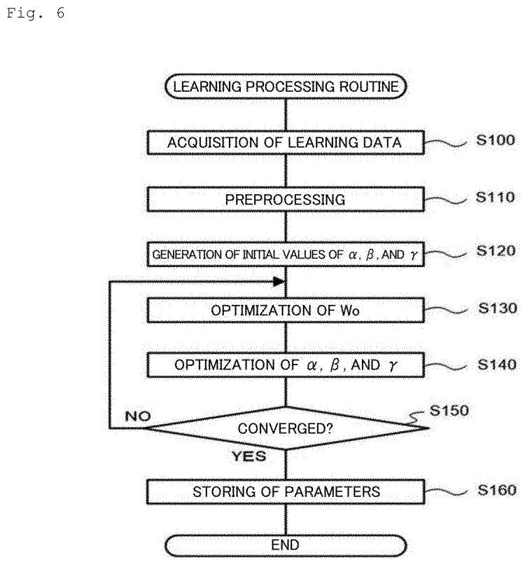

at the K observation points at time points t-t_{w}+1, t-t_{w}+2, t are input (FIG. 5).

Also, a set

[symbol]

of first weight matrices indicating the influence of the numbers of passersby at other observation points with respect to each observation point, and a set

[symbol]

of second weight matrices indicating the influence of the numbers of passersby at the other observation points based on a travel route, with respect to each observation point, are defined by the following expressions (1) and (2).

[Formula 1]

[symbol]

={W_{a,t+1,t}_{_{w}}_{′}|t∈[1,T],t_{w}′∈[1,t_{w}]}, (1)

[symbol]

={W_{r,t+1,t}_{_{w}}_{′}|t∈[1,T],t_{w}′∈[1,t_{w}]} (2)

Here,

t_{w}′
is a variable that represents the difference between a prediction target time and a time point of input data that is used in prediction, and is defined as follows.

t_{w}′=[1,t_{w}]

Also,

W_{a,t+1,t}_{_{w}}_{′}
is a first weight matrix for considering the factor of a travel distance in comparison between conditions at a time point
t−t_{w}′+1
and conditions at the prediction target time point t+1, and
W_{a,t+1,t}_{_{w}}_{′}∈ [symbol] ^{K×K}
More specifically,
W_{a,t+1,t}_{_{w}}_{′}
where

t=[1,T],t_{w}′=[1,t_{w}]

is a K×K matrix for considering the influence that the number of passersby
Xₜ₋ₜ_{_{w}}_{′}+1
at a time point preceding the prediction target time point t+1 by
t_{w}′
has on the number of passersby

### Xₜ₊₁

at the prediction target time point, from the standpoint of a travel distance between observation points and the like.

The first weight matrix

W_{a,t+1,t}_{_{w}}_{′}
can vary according to a time point in order to consider a change in the travel distance between different observation points due to traffic regulation (closure of a road, etc.). If there is no influence of traffic regulation and the like in the observation period, for example, the first weight matrix that represents the influence from a just preceding time point is

W_{a,t+1,1}=W_{a,t,1}= . . . =W_{a,2,1}.

A set of the first weight matrices

W_{a,t+1,t}_{_{w}}_{′}
is

[symbol]

A second weight matrix

W_{r,t+1,t}_{_{w}}_{′}
is a weight matrix for considering the factor of a travel distance in comparison between conditions at the time point
t−t_{w}′+1
and conditions at the prediction target time point t+1, and
W_{r,t+1,t}_{_{w}}_{′}∈ [symbol] ^{K×K}
More specifically, the second weight matrix, where

t=[1,T],t_{w}′=[1,t_{w}],

is a K×K matrix for considering the influence that the number of passersby
Xₜ₋ₜ_{_{w}}_{′}+1
at the time point preceding the prediction target time point t+1 by
t_{w}′
has on the number of passersby

### Xₜ₊₁

at the prediction target time point, from the standpoint of a travel route.

The second weight matrix

W_{r,t+1,t}_{_{w}}_{′}
can vary according to a time point in order to consider a change of a main travel route according to a time zone, a day in the week, and the like. If there is no change in the travel route and the like in the observation period, for example, the second weight matrix that represents the influence from a just preceding time point is

W_{r,t+1,1}=W_{r,t,1}= . . . =W_{r,2,1}.

If there is no information regarding the travel route and the like from the time point
t−t_{w}′+1
to the time point t+1, the second weight matrix is

W_{r,t+1,t}_{_{w}}_{′}=O

Here,

### O

is a zero matrix.

A set of the second weight matrices

W_{r,t+1,t}_{_{w}}_{′}
is

[symbol]

Input of the first weight matrix

W_{a,t+1,t}_{_{w}}_{′}
is given by a person, and input of the second weight matrix
W_{r,t+1,t}_{_{w}}_{′}
may be given by a person or estimated in advance.

The input unit 100 gives accepted

X, [symbol] , [symbol] , K, T, t, t_{w}
to the preprocessing unit 200.

The preprocessing unit 200 performs preprocessing that is necessary for learning processing performed by the learning unit 300, on

X, [symbol] , [symbol] , K, T, t, t_{w}
accepted by the input unit 100.

Specifically, according to a learning algorithm (e.g., deep learning, a Markov chain, or the like) that is used by the learning unit 300, the preprocessing unit 200 performs processing for adjusting the size of the matrices and the like on

X, [symbol] , [symbol] , K, T, t, t_{w}
accepted by the input unit 100.

Then, the preprocessing unit 200 gives the processed data

X, [symbol] , [symbol] , K, T, t, t_{w}
to the learning unit 300.

The learning unit 300 learns parameters of a prediction model with respect to each of the plurality of observation points based on the learning data. This learning is performed such that the number of passersby at an observation point at a prediction time point predicted using the following prediction model matches the number of passersby at a time point corresponding to the prediction time point included in the learning data. The prediction model is a prediction model that has parameters including the set

[symbol]

of first weight matrices, the set

[symbol]

of second weight matrices, and a set

[symbol]

of third weight matrices that differ from the first weight matrix
W_{a,t+1,t}_{_{w}}_{′}
and the second weight matrix
W_{r,t+1,t}_{_{w}}_{′}
and indicate the influence of the numbers of passersby at the other observation points.

Specifically, the learning unit 300 learns, as the prediction model, a function F in which the data

X, [symbol] , [symbol] , K, T, t, t_{w}
processed by the preprocessing unit 200 is used as input (the following expression (3)).

[Formula 2]

\hat{X}ₜ₊₁=F(X, [symbol] , [symbol] ,K,T,t,t_{w}′) (3)

Here,

\hat{X}ₜ₊₁=[\hat{x}_{1,t+1},\hat{x}_{2,t+1}, . . . ,\hat{x}_{K,t+1}]

is a prediction value of the number of passersby at each observation point at the time point t+1. In one example, the function F, which is the prediction model, can be expressed by the following expression (4).

$$\begin{matrix} [ Formula 3 ] & \\ F ( X , {𝒲}_{a} , {𝒲}_{r} , K , T , t , {t}_{w} ) = {\sum }_{{t}_{w}^{′} = 1}^{{t}_{w}} ( {α}_{t + 1 , {t}_{w}^{′}} {W}_{a , t + 1 , {t}_{w}^{′}} + {β}_{t + 1 , {t}_{w}^{′}} {W}_{a , t + 1 , {t}_{w}^{′}} + {γ}_{t + 1 , {t}_{w}^{′}} {W}_{r , t + 1 , {t}_{w}^{′}} ) {X}_{t - {t}_{w}^{′} + 1} & ( 4 )\end{matrix}$$

In the above expression (4),

W_{o,t+1,t}_{_{w}}_{′}
is a third weight matrix for considering another factor that is not considered when the influence (
W_{a,t+1,t}_{_{w}}_{′}
) of a travel distance between observation points and the like and the influence (
W_{r,t+1,t}_{_{w}}_{′}
) of travel route information are considered.

[symbol]

is a set of the third weight matrices
W_{o,t+1,t}_{_{w}}_{′}
and is defined by the following expression (5).

[Formula 4]

[symbol]

={W_{o,t+1,t}_{_{w}}_{′}|t∈[1,T],t_{w}′∈[1,t_{w}]} (5)

Also, in the above expression (4),

α_{t+1,t}_{_{w}}_{′}, β_{t+1,t}_{_{w}}_{′}, γ_{t+1,t}_{_{w}}_{′}
are parameters that determine the influence of the weight matrices
W_{o,t+1,t}_{_{w}}_{′}, W_{a,t+1,t}_{_{w}}_{′}, W_{r,t+1,t}_{_{w}}_{′},
and sets of values of the respective parameters are defined by the following expressions (6) to (8).

[Formula 5]

α={α_{t+1,t}_{_{w}}_{′}|t∈[1,T],t_{w}′∈[1,t_{w}]}, (6)

β={β_{t+1,t}_{_{w}}_{′}|t∈[1,T],t_{w}′∈[1,t_{w}]}, (7)

γ={γ_{t+1,t}_{_{w}}_{′}|t∈[1,T],t_{w}′∈[1,t_{w}]}, (8)

If there is no information regarding the travel route and the like from the time point

t−t_{w}′+1
to the time point t+1 (

W_{r,t+1,t}_{_{w}}_{′}=O

),

γ_{t+1,t}_{_{w}}_{′}=0

The learning unit 300 performs optimization regarding the function

F(X, [symbol] , [symbol] , K, T, t, t_{w})
by minimizing an objective function expressed by the following expression (9), using a learning algorithm such as deep learning or a Markov chain.

$$\begin{matrix}[ Formula 6 ] & \\ L = {\sum }_{t = 1}^{T} {\sum }_{k = 1}^{N} \vert {x}_{k , t} - {\hat{x}}_{k , t} \vert & ( 9 )\end{matrix}$$

The above expression (9) means that the set of third weight matrices and the parameters

( [symbol] , α, β, γ)
of the function F are optimized and a prediction model for an observation target is computed, such that the difference between an observation value and a prediction value of the number of passersby at each observation point from a time point 1 to a time point T is minimized.

Then, the learning unit 300 stores the set of third weight matrices and the parameters

( [symbol] , α, β, γ)
of the function F, which is the prediction model obtained through the above-described optimization, in the parameter storing unit 400.

The parameter storing unit 400 stores the parameters

( [symbol] , α, β, γ)
of the prediction model.

The input unit 500 accepts the following three types of input with respect to each of a plurality of observation points. First input is observation data that includes an observation time point of the observation point and the number of passersby at the observation point at the observation time point. Second input is a set of first weight matrices regarding each observation point that indicate the influence of the numbers of passersby at other observation points based on distances to the other observation points. Third input is a set of second weight matrices regarding each observation point that indicate the influence of the numbers of passersby at the other observation points based on a travel route.

Specifically, the input unit 500 accepts input of

(X, [symbol] , [symbol] , K, T, t, t_{w})
as input data.

Then, the input unit 500 gives the accepted data

X, [symbol] , [symbol] , K, T, t, t_{w}
to the preprocessing unit 600.

The preprocessing unit 600 performs preprocessing that is necessary for prediction processing performed by the prediction unit 700, on

X, [symbol] , [symbol] , K, T, t, t_{w}
accepted by the input unit 500.

Specifically, according to the learning algorithm (e.g., deep learning, a Markov chain, or the like) used by the learning unit 300, the preprocessing unit 600 performs processing for adjusting the size of the matrices and the like on

X, [symbol] , [symbol] , K, T, t, t_{w}
accepted by the input unit 500.

Then, the preprocessing unit 600 gives the processed data

X, [symbol] , [symbol] , K, T, t, t_{w}
to the prediction unit 700.

The prediction unit 700 predicts the number of passersby at a prediction time point with respect to each of the plurality of observation points from the observation data, based on the following prediction model. The prediction model is the prediction model that is learned by the learning unit 300 and in which the set of first weight matrices and the set of second weight matrices that are input are used.

Specifically, the prediction unit 700 acquires the parameters

( [symbol] , α, β, γ)
of the prediction model from the parameter storing unit 400, and predicts the number of passersby

### \hat{X}ₜ₊₁

at the prediction time point t+1 by using the function
F(X, [symbol] , [symbol] , K, T, t, t_{w})

Then, the prediction unit 700 gives the predicted number of passersby

### \hat{X}ₜ₊₁

at the prediction time point t+1 to the output unit 800.

The output unit 800 outputs the number of passersby

### \hat{X}ₜ₊₁

at the prediction time point t+1 predicted by the prediction unit 700.

<Functions of Time Series Learning and Prediction Apparatus According to First Embodiment of the Invention>

FIG. 6 is a flow chart showing a learning processing routine according to an embodiment of the present invention.

When learning data, a set of first weight matrices, and a set of second weight matrices are input to the input unit 100, the learning processing routine shown in FIG. 6 is executed in the time series learning and prediction apparatus 10.

First, in step S100, the input unit 100 accepts input of learning data, a set of first weight matrices, and a set of second weight matrices.

In step S110, the preprocessing unit 200 performs preprocessing that is necessary for learning processing performed by the learning unit 300, on

X, [symbol] , [symbol] , K, T, t, t_{w}
accepted by the input unit 100.

In step S120, the learning unit 300 initializes parameters α, β, and γ of the prediction model that determine the influence of the weight matrices

W_{o,t+1,t}_{_{w}}_{′}, W_{a,t+1,t}_{_{w}}_{′}, W_{r,t+1,t}_{_{w}}_{′}.

In step S130, the learning unit 300 optimizes a set

[symbol]

of third weight matrices, which is a parameter of the prediction model, by using the current parameters α, β, and γ, such that the number of passersby at an observation point at a prediction time point predicted using the prediction model matches the number of passersby at a time point corresponding to the prediction time point included in the learning data.

In step S140, the learning unit 300 optimizes the parameters α, β, and γ of the prediction model by using the set

[symbol]

of third weight matrices, which is the parameter of the current prediction model, such that the number of passersby at an observation point at a prediction time point predicted using the prediction model matches the number of passersby at a time point corresponding to the prediction time point included in the learning data.

In step S150, the learning unit 300 determines whether or not the learning has converged.

Upon determining that the learning has not converged (NO in step S150), the learning unit 300 returns to step S130 and again performs optimization.

In contrast, upon determining that the learning has converged (YES in step S150), in step S160, the learning unit 300 stores the set of third weight matrices and the parameters

( [symbol] , α, β, γ)
of the function F, which is the prediction model obtained through the above-described optimization, in the parameter storing unit 400.

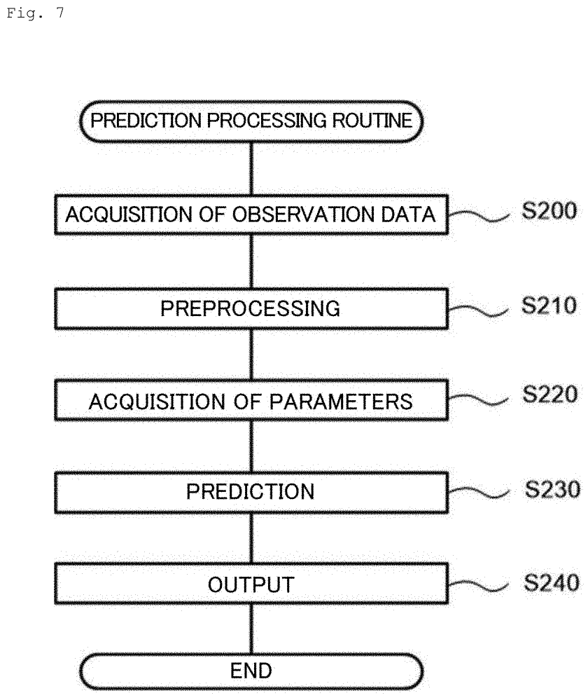

FIG. 7 is a flow chart showing a prediction processing routine according to an embodiment of the present invention.

When observation data, a set of first weight matrices, and a set of second weight matrices are input to the input unit 500, the prediction processing routine shown in FIG. 7 is executed in the time series learning and prediction apparatus 10.

First, in step S200, the input unit 500 accepts, with respect to each of a plurality of observation points, input of observation data that includes an observation time point of the observation point and the number of passersby at the observation point at the observation time point, a set of first weight matrices, and a set of second weight matrices.

In step S210, the preprocessing unit 600 performs preprocessing that is necessary for prediction processing performed by the prediction unit 700, on

X, [symbol] , [symbol] , K, T, t, t_{w}
accepted by the input unit 500.

In step S220, the prediction unit 700 acquires the parameters

( [symbol] , α, β, γ)
of the prediction model from the parameter storing unit 400.

In step S230, the prediction unit 700 predicts the number of passersby

### \hat{X}ₜ₊₁

at the prediction time point t+1 by using the function
F(X, [symbol] , [symbol] , K, T, t, t_{w})
which is the prediction model.

In step S240, the output unit 800 outputs the number of passersby

### \hat{X}ₜ₊₁

at the prediction time point t+1 predicted in the above-described step S230.

<Results of Experiments of Time Series Learning and Prediction Apparatus according to First Embodiment of the Invention>

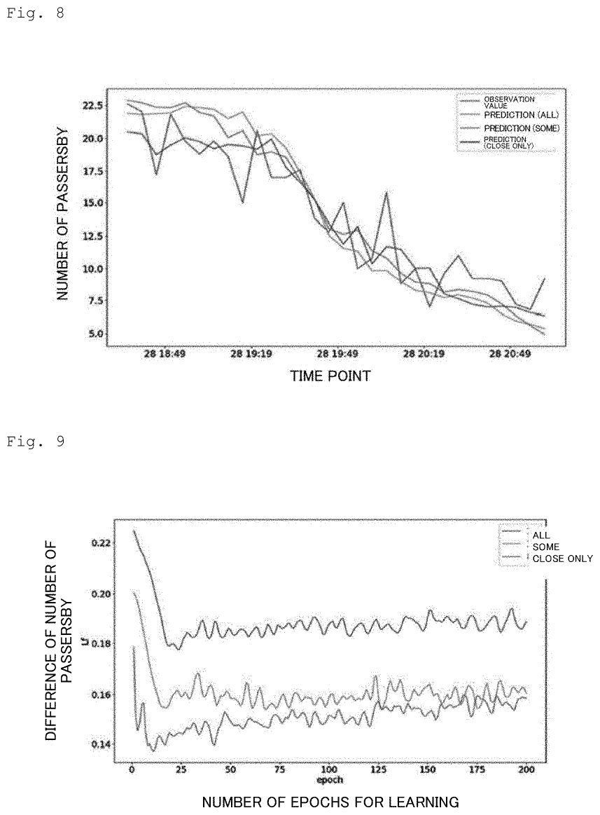

FIGS. 8 to 10 show results of experiments performed using the time series learning and prediction apparatus 10 according to an embodiment of the present invention.

FIGS. 8 to 10 are examples of experiments and show that in a case in which only data regarding close observation points was input rather than data regarding all observation points, precision was improved when compared to cases in which data regarding only some or all observation points was used, and precision varied as a result of the direction of a travel route being considered.

FIG. 8 is a graph showing a relationship between a time point and the number of passersby for each of the case of actual observation values, a case in which the number of passersby was predicted based on all observation points, a case in which the number of passersby was predicted based on some observation points, and a case in which the number of passersby was predicted with consideration given to position information and the like regarding observation points. FIG. 9 is a graph in which the difference between an actual observation value and a prediction value of the number of passersby at a given time point is plotted with respect to the number of epochs for learning, for each of a case in which the number of passersby was predicted based on all observation points, a case in which the number of passersby was predicted based on some observation points, and a case in which the number of passersby was predicted with consideration given to position information and the like regarding observation points.

As shown in FIG. 9, in a case in which only data regarding close observation points was used, the difference was small when compared to cases in which data regarding all observation points was input and data regarding only some or all observation points was used. This result shows that precision was improved when only data regarding close observation points was used.

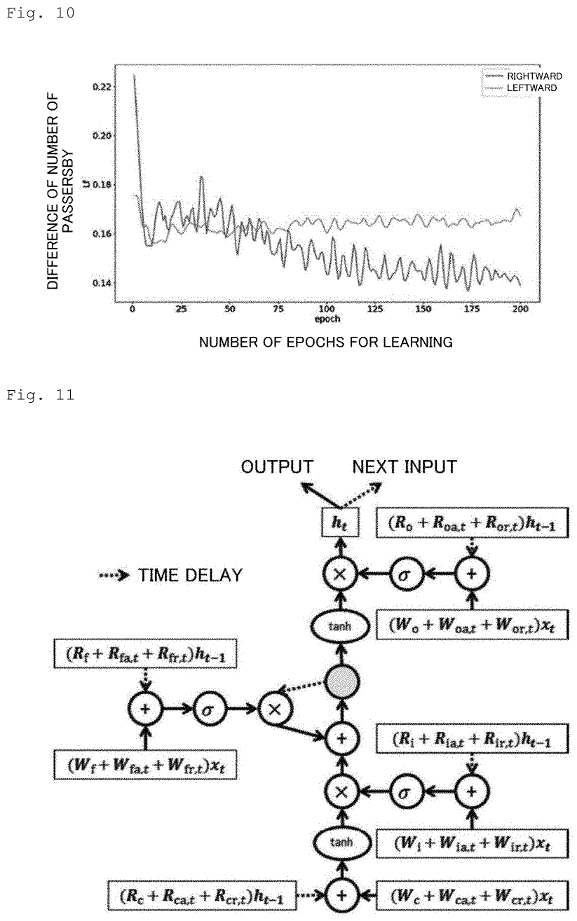

FIG. 10 is a diagram in which the difference between an observation result and a prediction result in a time zone in which the number of passersby traveling rightward along a travel route was large is plotted with respect to the number of epochs for learning, for observation points that were located at the same position and at which the number of passersby traveling rightward and the number of passersby traveling leftward were respectively observed.

According to FIG. 10, the difference between an observation result and a prediction result varied as a result of the direction of the travel route being considered. This indicates that consideration given to the direction of the travel route affected precision. That is, the result shows that precision of the prediction was improved as a result of the travel route being considered.

As described above, the time series learning and prediction apparatus according to an embodiment of the present invention can learn a prediction model for precisely predicting the number of passersby at a prediction time point by learning parameters of the prediction model as described below. The learning is performed such that the number of passersby at each of a plurality of observation points at a prediction time point predicted using the following prediction model matches the number of passersby at a time point corresponding to the prediction time point included in the following learning data. The learning data is learning data that includes, with respect to each observation point, a past time point of the observation point and the number of passersby at the observation point at the past time point. The prediction model is a prediction model that has parameters including a first weight, a second weight, and a third weight with respect to each of the plurality of observation points, the first weight indicates the influence of the numbers of passersby at other observation points based on distances to the other observation points, the second weight indicates the influence of the numbers of passersby at the other observation points based on a travel route, and the third weight differs from the first weight and the second weight and indicates the influence of the numbers of passersby at the other observation points.

Also, the time series learning and prediction apparatus according to an embodiment of the present invention predicts, with respect to each of a plurality of observation points, the number of passersby at the observation point at a prediction time point from the following observation data by using the following prediction model. Therefore, the time series learning and prediction apparatus according to an embodiment of the present invention can precisely predict the number of passersby at the prediction time point. Here, the prediction model is a prediction model that has parameters including the following three weights and is learned in advance. A first weight is a weight that indicates the influence of the numbers of passersby at other observation points based on distances to the other observation points, with respect to each of the plurality of observation points. A second weight is a weight that indicates the influence of the numbers of passersby at the other observation points based on a travel route. A third weight is a weight that differs from the first weight and the second weight and indicates the influence of the numbers of passersby at the other observation points. The observation data is observation data that includes an observation time point of the observation point and the number of passersby at the observation point at the observation time point.

<Principle of Time Series Learning and Prediction Apparatus according to Second Embodiment of the Invention>

In the present embodiment, a case in which LSTM (Long Short Term Memory), which is one of recurrent neural networks, is used as the prediction model will be described.

If LSTM is used as the prediction model, parameters and the like are computed in the LSTM using the following expressions (10) to (15).

[Formula 7]

fₜ=σ((W_{f}+W_{fa,t}+W_{fr,t})Xₜ+(R_{f}+R_{fa,t}+R_{fr,t})hₜ₋₁), (10)

iₜ=σ((Wᵢ+W_{ia,t}+W_{ir,t})Xₜ+(Rᵢ+R_{ia,t}+R_{ir,t})hₜ₋₁), (11)

zₜ=tanh((W_{c}+W_{ca,t}+W_{cr,t})Xₜ+(R_{c}+R_{ca,t}+R_{cr,t})hₜ₋₁), (12)

cₜ=fₜ⊙cₜ₋₁+iₜ⊙zₜ, (13)

oₜ=σ((Wₒ+W_{oa,t}+W_{or,t})Xₜ+(Rₒ+R_{oa,t}+R_{or,t})hₜ₋₁), (14)

hₜ=oₜ⊙tanh(cₜ) (15)

Here,

⊙
is the element-wise product, and
σ(x)
is expressed by the following expression (16).

$$\begin{matrix}[ Formula 8 ] & \\ σ ( x ) = \frac{1}{1 + {e}^{- x}} , & ( 16 )\end{matrix}$$

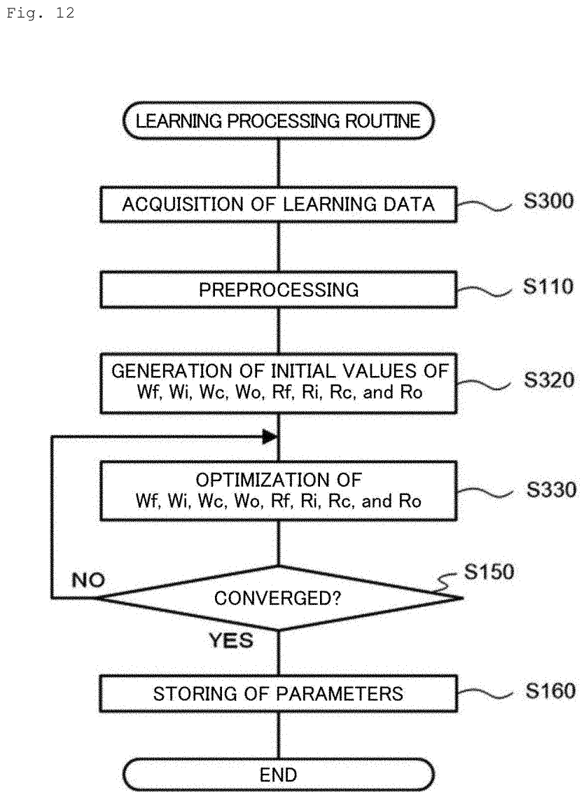

FIG. 11 shows an example in which the above expressions (10) to (15) are shown in a network configuration of the LSTM according to the present embodiment.

Here,

fₜ
is a parameter for computing a forget gate and determines a candidate to be disposed of from a cell state. Also,
iₜ
is a parameter for computing an input gate and determines a candidate for which the cell state is updated.
zₜ
computes a value for updating the cell state, and
oₜ
computes an output gate.
hₜ
is an output value of the LSTM and is a prediction value at a time point t+1 (corresponding to the prediction value

### \hat{X}ₜ₊₁

in the first embodiment), and

hₜ=[h_{1,t}h_{2,t}, . . . ,h_{K,t}].

The prediction value
hₜ
is not an input value, and is recurrently computed in the time series learning and prediction apparatus 10.

Out of matrices or vectors in the above expressions (10) to (15), except for those on the left side of the expressions

fₜ
and the like), an observation value

### Xₜ

that is input, and a prediction value
hₜ₋₁
that is recurrently computed in the time series learning and prediction apparatus 10, all matrices represent weight matrices.

Among these weight matrices,

W_{fa,t}, R_{fa,t}
are first weight matrices that indicate the influence of the numbers of passersby at other observation points based on distances to the other observation points, with respect to each observation point. Also,
W_{fr,t}, R_{fr,t}
are second weight matrices that indicate the influence of the numbers of passersby at the other observation points based on a travel route, with respect to each observation point.
W_{f}, Wᵢ, W_{c}, Wₒ, R_{f}, Rᵢ, R_{c}, Rₒ
are third weight matrices that differ from the first weight matrices
W_{fa,t}, R_{fa,t}
and the second weight matrices
W_{fr,t}, R_{fr,t}
and indicate the influence of the numbers of passersby at the other observation points, with respect to each observation point.

The third weight matrices

W_{f}, Wᵢ, W_{c}, Wₒ
and
R_{f}, Rᵢ, R_{c}, Rₒ
are matrices that are learned. The first weight matrices and the second weight matrices (
W_{fa,t}, W_{fr,t}, R_{fa,t}, R_{fr,t}
and the like) other than the third weight matrices are matrices that are input.

The first weight matrix

### W_{fa,t}

is a weight matrix for considering the influence of the observation value

### Xₜ

at a time point t in computation of the prediction value
hₜ
at the time point t+1 from the standpoint of a travel distance between observation points and the like. The second weight matrix

### W_{fr,t}

is a weight matrix for considering the influence of the observation value

### Xₜ

at the time point t in computation of the prediction value
hₜ
at the time point t+1 from the standpoint of a travel route and the like.

Also, the first weight matrix

### R_{fa,t}

is a weight matrix for considering the influence of the prediction value
hₜ₋₁
at the time point t in computation of the prediction value
hₜ
at the time point t+1 from the standpoint of a travel distance between observation points and the like. The second weight matrix

### R_{fr,t}

is a weight matrix for considering the influence of the prediction value
hₜ₋₁
at the time point t in computation of the prediction value
hₜ
at the time point t+1 from the standpoint of a travel route and the like.

In the expression (11) relating to the input gate and the expression (14) relating to the output gate as well, weight matrices are input. The following expressions (17) to (20) show sets of these weight matrices.

[Formula 9]

[symbol]

={W_{*,t}|t∈[1,T]}, (17)

[symbol]

={R_{*,t}|t∈[1,T]}, (18)

[symbol]

={ [symbol] |*=(fa,fr,ia,ir,ca,cr,oa,or)}, (19)

[symbol]

={ [symbol] |*=(fa,fr,ia,ir,ca,cr,oa,or)} (20)

Here, “*” corresponds to subscripts (fa, fr, ia, ir, ca, cr, oa, or). That is, prediction performed by the time series learning and prediction apparatus 10 according to the present embodiment is expressed as a function

F(X, [symbol] , [symbol] , K, T, t)
in which

### X, K, T, t

and [symbol]
, [symbol]
are used as input.

The optimum solution regarding the function F can be obtained by minimizing an objective function expressed by the following expression (21) with respect to eight weight matrices

W_{f}, Wᵢ, W_{c}, Wₒ, R_{f}, Rᵢ, R_{c}, Rₒ.

$$\begin{matrix}[ Formula 10 ] & \\ L = {\sum }_{t = 2}^{T} {\sum }_{k = 1}^{N} \vert {x}_{k , t} - {h}_{k , t - 1} \vert & ( 21 )\end{matrix}$$

The above expression (21) means that the difference between an observation value and a prediction value of the number of passersby at each observation point from a time point 2 to a time point T is minimized to compute a prediction model for an observation target.

<Configuration of Time Series Learning and Prediction Apparatus according to Second Embodiment of the Invention>

The following describes a configuration of a time series learning and prediction apparatus 20 according to the second embodiment of the present invention. Note that units of the configuration that are similar to those in the time series learning and prediction apparatus 10 according to the first embodiment are denoted with the same reference signs as those used in the first embodiment and a detailed description thereof is omitted.

The input unit 100 accepts the following three types of input with respect to each of a plurality of observation points. First input is learning data

### X, K, T, t

that includes a past time point of the observation point and the number of passersby at the observation point at the past time point. Second input is sets [symbol]
_{fa}, [symbol] _{fa}
of first weight matrices indicating the influence of the numbers of passersby at other observation points based on distances to the other observation points. Third input is sets [symbol]
_{fr}, [symbol] _{fr}
of second weight matrices indicating the influence of the numbers of passersby at the other observation points based on a travel route.

The learning unit 300 learns the third weight matrices

W_{f}, Wᵢ, W_{c}, Wₒ, R_{f}, Rᵢ, R_{c}, Rₒ
of the prediction model with respect to each of the plurality of observation points based on the learning data. This learning is performed such that the number of passersby at an observation point at a prediction time point predicted using the following prediction model matches the number of passersby at a time point corresponding to the prediction time point included in the learning data. The prediction model is a prediction model that has parameters including the sets [symbol]
, [symbol]
of first weight matrices, the sets [symbol]
_{fr}, [symbol] _{fr}
of second weight matrices, and the third weight matrices
W_{f}, Wᵢ, W_{c}, Wₒ, R_{f}, Rᵢ, R_{c}, Rₒ

Then, the learning unit 300 stores the third weight matrices

W_{f}, Wᵢ, W_{c}, Wₒ, R_{f}, Rᵢ, R_{c}, Rₒ
of the function
F(X, [symbol] , [symbol] , K, T, t),
which is the prediction model obtained through the above-described optimization, in the parameter storing unit 400.

The input unit 500 accepts the following three types of input with respect to each of a plurality of observation points. First input is observation data

### X, K, T, t

that includes an observation time point of the observation point and the number of passersby at the observation point at the observation time point. Second input is sets [symbol]
, [symbol] _{fa}
of first weight matrices indicating the influence of the numbers of passersby at other observation points based on distances to the other observation points. Third input is sets [symbol]
_{fr}, [symbol] _{fr}
of second weight matrices indicating the influence of the numbers of passersby at the other observation points based on a travel route.

The prediction unit 700 predicts the number of passersby

hₜ
at a prediction time point with respect to each of the plurality of observation points from the observation data

### X, K, T, t

based on the following prediction model. The prediction model is the prediction model
F(X, [symbol] , [symbol] , k, T, t)
in which the sets [symbol]
, [symbol] _{fa}
of first weight matrices and the sets [symbol]
_{fr}, [symbol] _{fr}
of second weight matrices are used and that is learned by the learning unit 300.

<Functions of Time Series Learning and Prediction Apparatus according to Second Embodiment of the Invention>

FIG. 12 is a flow chart showing a learning processing routine according to the second embodiment of the present invention. Note that steps of the processing that are similar to those in the learning processing routine according to the first embodiment are denoted with the same reference signs as those used in the first embodiment and a detailed description of which is omitted.

In step S300, the input unit 100 accepts the following three types of input with respect to each of a plurality of observation points. First input is learning data

### X, K, T, t

that includes a past time point of the observation point and the number of passersby at the observation point at the past time point. Second input is sets [symbol]
, [symbol] _{fa}
of first weight matrices indicating the influence of the numbers of passersby at other observation points based on distances to the other observation points. Third input is sets [symbol]
_{fr}, [symbol] _{fr}
of second weight matrices indicating the influence of the numbers of passersby at the other observation points based on a travel route.

In step S320, the learning unit 300 sets initial values for the third weight matrices

W_{f}, Wᵢ, W_{c}, Wₒ, R_{f}, Rᵢ, R_{c}, Rₒ.

In step S130, the learning unit 300 optimizes the third weight matrices

W_{f}, Wᵢ, W_{c}, Wₒ, R_{f}, Rᵢ, R_{c}, Rₒ,
which are parameters of the prediction model, as described below. The optimization is performed such that the number of passersby at an observation point at a prediction time point predicted using the prediction model matches the number of passersby at a time point corresponding to the prediction time point included in the learning data.

Note that a prediction processing routine according to the second embodiment is similar to that in the first embodiment.

As described above, the time series learning and prediction apparatus according to an embodiment of the present invention can learn a prediction model for precisely predicting the number of passersby at a prediction time point, by learning parameters of the prediction model that is a recurrent neural network.

Also, the time series learning and prediction apparatus according to an embodiment of the present invention can precisely predict the number of passersby at an observation point at a prediction time point by predicting the number of passersby at the prediction time point by using the prediction model that is a recurrent neural network learned in advance.

Note that the present invention is not limited to the above-described embodiments, and various modifications and applications can be made within a scope not departing from the gist of the invention.

In the above-described embodiments, a case in which a single apparatus is configured to perform learning and prediction is described, but the present invention is not limited to this configuration, and a time series learning apparatus that performs learning and a time series prediction apparatus that performs prediction may also be configured separately from each other.

Also, in the above-described example, a first weight matrix and a second weight matrix are input together with observation data when prediction is performed, but the present invention is not limited to this example, and if prediction is performed using a first weight matrix and a second weight matrix that are the same as those used in learning, input of the first weight matrix and the second weight matrix may also be omitted.

A program is installed in advance in the embodiments described in the present specification, but it is also possible to provide the program in a state of being stored in a computer-readable recording medium.

### REFERENCE SIGNS LIST

10 Time series learning and prediction apparatus
20 Time series learning and prediction apparatus
100 Input unit
200 Preprocessing unit
300 Learning unit
400 Parameter storing unit
500 Input unit
600 Preprocessing unit
700 Prediction unit
800 Output unit

1. A time series learning apparatus configured to learn, with respect to each of a plurality of observation points, parameters of a prediction model for predicting the numbers of passersby at the plurality of observation points at a prediction time point based on the numbers of passersby at the plurality of observation points at an observation time point that are input, the time series learning apparatus comprising:
an accepter configured to accept input of:
learning data,
a first weight, and
a second weight with respect to each of the plurality of observation points,
wherein the learning data include a past time point of each of the plurality of observation points and a number of passersby at each of the plurality of observation points at the past time point,
wherein the first weight includes a first influence value of the numbers of passersby at other observation points based on distances to the other observation points, and
wherein the second weight includes a second influence value of the numbers of passersby at the other observation points based on a travel route; and
a learner configured to learn parameters of the prediction model with respect to each of the plurality of observation points based on the learning data,
wherein the number of passersby at one of the plurality of observation points at a prediction time point predicted using the prediction model matches the number of passersby at a time point corresponding to the prediction time point included in the learning data, and
wherein the prediction model having parameters include:
the first weight,
the second weight, and
a third weight that differs from the first weight and the second weight and indicates the influence of the numbers of passersby at the other observation points.

2. The time series learning apparatus according to claim 1,
wherein the prediction model includes a recurrent neural network.

3. The time series learning apparatus of claim 1, wherein the time series learning apparatus is further configured to predict the number of passersby at each of the plurality of observation points at the prediction time point by using the prediction model for predicting the numbers of passersby at the plurality of observation points at the prediction time point based on the numbers of passersby at the plurality of observation points at the observation time point, the time series learning apparatus further comprising:
the accepter configured to accept input of the observation data associated with the plurality of observation points, wherein the observation data include:
the observation time point of one of the plurality of observation points and
the number of passersby at the one of the plurality of observation points at the observation time point; and
a predictor configured to predict the number of passersby at the one of the plurality of observation points at the prediction time point from the observation data by using the prediction model,
wherein the prediction model is learned in advance and has parameters including the first weight, the second weight, and the third weight with respect to the observation point.

4. The time series learning apparatus according to claim 3,
wherein the predictor predicts the number of passersby at the observation point at the prediction time point from the observation data by using the first weight and the second weight accepted by the accepter as the first weight and the second weight included in the parameters of the prediction model.

5. A time series learning method for learning, with respect to each of a plurality of observation points, parameters of a prediction model for predicting the numbers of passersby at the observation points at a prediction time point based on the numbers of passersby at the observation points at an observation time point that are input, the time series learning method comprising:
accepting, by a receiver, input including:
learning data,
a first weight, and
a second weight associated with an observation point in the plurality of the observation points,
wherein the learning data include a past time point of the observation point and the number of passersby at the observation point at the past time point,
wherein the first weight includes a first influence value of the numbers of passersby at another observation point based on a distance from the observation point to the other observation point, and
wherein the second weight includes a second influence value of the numbers of passersby at the other observation point based on a travel route; and
learning, by a learner, parameters of the prediction model with respect to each of the plurality of observation points based on the learning data,
wherein the number of passersby at the observation point at a prediction time point predicted using the prediction model matches the number of passersby at a time point corresponding to the prediction time point included in the learning data, and
wherein the prediction model has parameters including:
the first weight,
the second weight, and
a third weight that is distinct from the first weight and the second weight and indicates the influence of the numbers of passersby at the other observation point.

6. A time series prediction method for predicting a number of passersby at each of a plurality of observation points at a prediction time point by using a prediction model for predicting the numbers of passersby at the plurality of observation points at a prediction time point based on the numbers of passersby at the plurality of observation points at an observation time point, the time series prediction method comprising:
accepting, by a receiver, observation data with respect to each of the plurality of observation points,
wherein the observation data include an observation time point of an observation point in the plurality of observation points and the number of passersby at the observation point at the observation time point; and
predicting, by a predictor, the number of passersby at the observation point at the prediction time point from the observation data using the prediction model,
wherein the prediction model is previously trained,
wherein the prediction model has parameters including a first weight, a second weight, and a third weight with respect to the observation point,
wherein the first weight including a first influence value of the numbers of passersby at another observation point based on distances from the observation point to the other observation point,
wherein the second weight including a second influence value of the numbers of passersby at the other observation point based on a travel route, and
wherein the third weight is distinct from the first weight and the second weight and includes a third influence value of the numbers of passersby at the other observation point.

7. (canceled)

8. The time series learning apparatus according to claim 1, wherein each of the observation points depend on a direction of a passerby traffic through the observation point.

9. The time series learning apparatus according to claim 1, wherein each of the observation points and the other observation points represent a same location with distinct respective directions of passerby traffic through the same location.

10. The time series learning apparatus according to claim 1, wherein the first weight includes the first influence value of the numbers of passersby at the other observation points based on distances to the other observation points at the past time point, and wherein the distances vary over time based at least on a closure of at least a part of the travel route.

11. The time series learning apparatus according to claim 1, wherein the second weight includes the second influence value of the numbers of passerby at the other observation points based on the travel route at the past time point, and wherein the travel route is based on time of day.

12. The time series learning apparatus according to claim 1, wherein the learner optimizes the prediction model by minimizing a difference between the number of passersby at one of the plurality of observation points at the prediction time point predicted using the prediction model and the number of passersby at the time point corresponding to the prediction time point included in the learning data.

13. The time series learning apparatus according to claim 1, the apparatus further comprising:
the learner further configured to determine the third weight of the prediction model.

14. The time series learning method according to claim 5, wherein the prediction includes a recurrent neural network.

15. The time series learning method according to claim 5, wherein the observation point depends on a direction of a passerby traffic through the observation point.

16. The time series learning method according to claim 5, wherein the observation point and the other observation point represent a same location with distinct respective directions of passerby traffic through the same location.

17. The time series learning method according to claim 5, wherein the first weight includes the first influence value of the numbers of passersby at the other observation point based on distances from the observation point to the other observation point at the past time point, and wherein the distances vary over time based at least on a closure of at least a part of the travel route.

18. The time series learning method according to claim 5, wherein the second weight includes the second influence value of the numbers of passerby at the other observation point based on the travel route at the past time point, and wherein the travel route is based on time of day.

19. The time series learning method according to claim 5, wherein the learner optimizes the prediction model by minimizing a difference between the number of passersby at one of the plurality of observation points at the prediction time point predicted using the prediction model and the number of passersby at the time point corresponding to the prediction time point included in the learning data.

20. The time series learning method according to claim 5, the method further comprising:
determining, by the learner, the third weight of the prediction model.

21. The time series prediction method according to claim 6, the method further comprising:
receiving, based on the observation point, the first weight and the second weight of the previously trained prediction model; and
predicting the number of passerby at the observation point at the prediction time point using the received first weight and second weight.
